(19) United States
(12) Patent Application Publication
(10) Pub. No.: US 2026/0126547 A1
(43) Pub. Date: May 7, 2026

(54) FLIGHT VISION SYSTEM (EFVS) FOR AN AIRCRAFT, THE SYSTEM COMPRISING A MILLIMETER RADAR (RDRMM)

(71) Applicant: THALES, MEUDON (FR)

(72) Inventors: Pierre-Yves DUMAS, VALENCE (FR); Yoan VEYRAD, MERIGNAC (FR)

(21) Appl. No.: 19/117,375

(22) PCT Filed: Oct. 4, 2023
(86) PCT No.: PCT/EP2023/077447

§ 371 Date: Mar. 31, 2025

(30) Foreign Application Priority Data
Oct. 5, 2022 (FR) 2210189

(51) Int. Cl. G01S 13/934; B64D 41/00; B64D 43/00; B64D 45/08; G01S 13/88

(52) U.S. Cl. CPC G01S 13/934; B64D 41/00; B64D 43/00; B64D 45/08; G01S 13/882

(57) ABSTRACT

A flight vision system for an aircraft includes a millimeter radar and an electronic control unit configured to manage, during a landing phase on a runway, an expansion of the horizontal aperture of the field of view of the millimeter radar around a predefined horizontal aperture of the field of view depending on the drift of the aircraft, when the height of the aircraft relative to the runway threshold becomes less than an expansion threshold.

### CROSS-REFERENCE TO RELATED APPLICATIONS

This application is a National Stage of International patent application PCT/EP2023/077447, filed on Oct. 4, 2023, which claims priority to foreign French patent application No. FR 2210189, filed on Oct. 5, 2022, the disclosures of which are incorporated by reference in their entireties.

### FIELD OF THE INVENTION

The invention relates to a flight vision system (EFVS (Enhanced Flight Vision System)) for an aircraft, comprising a millimeter radar.

### BACKGROUND

A millimeter radar is understood to mean a radar with ultra-high frequencies ranging between 30 and 300 GHz.

Current flight vision systems, or EFVS, are based on the use of an optical, generally infrared or multispectral, sensor mounted on the aircraft containing the EFVS, which sensor allows, under certain adverse weather conditions, the crew to be provided with a better quality image than that seen by the pilot.

By allowing the runway to be seen (under certain foggy or reduced visibility conditions) and therefore the landing to continue, the flight vision system EFVS decreases aborted landing rates and diversions in the event of adverse weather conditions.

On an operational level, during the approach phase, at the altitude or decision height the crew is authorized to continue the approach if the visual references (runway or approach lighting), not perceptible with natural vision, are present in the image provided by the EFVS sensor. The approach can then continue:
up to 100 feet from the ground, for EFVS-100 ft (FAA) or EFVS-A (EASA), which is the height at which the crew must see the runway references with natural vision in order to complete the landing; or
up to ground level for EFVS-to land (FAA) or EFVS-L (EASA).

EFVS-100 ft operations have existed for several years in Europe and the United States. Certified EFVS solutions exist.

EFVS-to land operations have been authorized by the FAA (Federal Aviation Administration) from the end of 2016 and in Europe from 2022.

EFVS operations are currently limited to business aviation due to the cost of the sensor. Furthermore, the performance capabilities of the current sensors do not allow vision under all weather conditions, as sometimes the pilot sees better than the sensor.

The flight vision systems EFVS that are currently on the market use optical (infrared or multispectral) sensors, the performance capabilities of which are unsatisfactory under certain weather conditions, for example, fog or rain.

In addition, the gradual replacement of incandescent approach lighting with LED approach lighting (for reliability and energy consumption reasons) on runways will make these sensors increasingly less efficient, because infrared sensors are ineffective with LED lamps, the radiation of which in the IR band is much lower than that of conventional incandescent lamps.

### SUMMARY OF THE INVENTION

An aim of the invention is to overcome the aforementioned problems, and notably to provide an enhanced flight vision system (EFVS) for an aircraft.

According to one aspect of the invention, a flight vision system is proposed for an aircraft, comprising a millimeter radar and an electronic control unit configured to manage, during a landing phase on a runway, an expansion of the horizontal (or azimuth) aperture of the field of view of the millimeter radar around a predefined horizontal aperture (or width) of the field of view depending on the drift of the aircraft, when the height of the aircraft relative to the runway threshold becomes less than an expansion threshold.

According to one embodiment, the electronic control unit is configured to manage, during a landing phase on a runway, an expansion of the vertical (or height) aperture of the field of view of the millimeter radar around a predefined vertical (or height) aperture of the field of view, when the height of the aircraft relative to the runway threshold becomes less than the expansion threshold.

In one embodiment, the electronic control unit is configured to compute the height of the aircraft relative to the runway threshold based on an altitude relative to the sea level. The altitude relative to the sea level is computed based on the atmospheric pressure measured by a barometer, and/or on an altitude relative to the ground measured by a radio altimeter and/or on a distance to the runway threshold measured by a distance measurement device.

According to one embodiment, the electronic control unit is configured to expand the horizontal aperture of the field of view of the millimeter radar from the predefined horizontal aperture of the field of view to a constant wider horizontal aperture, when the height of the aircraft relative to the runway threshold drops below the expansion threshold.

As a variant, the electronic control unit is configured to gradually expand the horizontal aperture of the field of view of the millimeter radar from the predefined horizontal aperture of the field of view to an wider horizontal aperture depending on the height of the aircraft, when the height of the aircraft relative to the runway threshold drops below the expansion threshold.

In one embodiment, the electronic control unit is configured to gradually expand the horizontal aperture of the field of view of the millimeter radar from the predefined horizontal aperture of the field of view to an wider horizontal aperture depending on the height of the aircraft, when the height of the aircraft relative to the runway threshold drops below the expansion threshold, taking into account the position of the aircraft and the runway width provided by a database.

As a variant or in combination, the electronic control unit is configured to gradually expand the horizontal aperture of the field of view of the millimeter radar from the predefined horizontal aperture of the field of view to an wider horizontal aperture depending on the height of the aircraft, when the height of the aircraft relative to the runway threshold drops below the expansion threshold, taking into account data representing further details of the parameters comprising the attitude, and/or the drift, and/or the position of the aircraft.

As a variant or in combination, the electronic control unit is configured to gradually expand the horizontal aperture of the field of view of the millimeter radar from the predefined horizontal aperture of the field of view to an wider horizontal aperture depending on the height of the aircraft, when the height of the aircraft relative to the runway threshold drops below the expansion threshold, taking into account characteristic data of the yaw stability of the aircraft.

According to one embodiment, the electronic control unit is configured to modify the waveform of the millimeter radar when the height of the aircraft relative to the runway threshold becomes less than a modification threshold.

For example, the modification threshold is equal to the expansion threshold.

As a variant, the electronic control unit is configured to expand the horizontal aperture of the field of view of the millimeter radar, and/or to modify the waveform of the millimeter radar, as a function of manual control by the aircraft pilot.

### BRIEF DESCRIPTION OF THE DRAWINGS

The invention will be better understood with reference to some embodiments that are described by way of non-limiting examples and are illustrated by the appended drawings, in which:

FIG. 1 schematically illustrates a flight vision system for an aircraft according to one aspect of the invention; and

FIG. 2 schematically illustrates the operation of the system of FIG. 1, according to one aspect of the invention.

Throughout all the figures, the elements with identical reference signs are similar.

### DETAILED DESCRIPTION

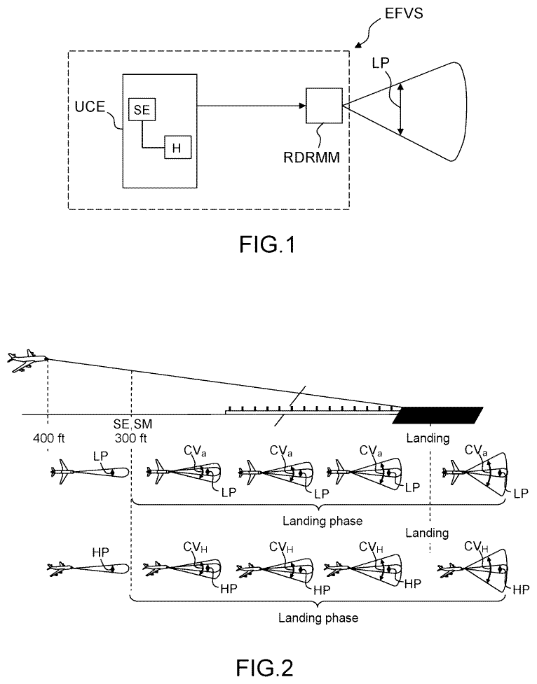

FIG. 1 schematically shows a flight vision system EFVS for an aircraft, comprising a millimeter radar RDRMM and an electronic control unit UCE. The electronic control unit UCE is configured to manage, during a landing phase on a runway, an expansion of the azimuth or the horizontal aperture of the field of view of the millimeter radar RDRMM around a predefined horizontal aperture of the field of view LP depending on the drift of the aircraft, when the height H of the aircraft relative to the runway threshold becomes less than an expansion threshold SE.

For example, the expansion threshold SE is 200 feet (or ft), as illustrated in FIG. 2.

The present invention describes the automatic or manual configuration logic of a certain number of generic parameters of an on-board millimeter radar in order to best optimize its use in various use cases.

An electronic millimeter scanning radar, RDRMM, is characterized by a certain number of parameters.

Certain parameters are generally set during the design phase as a function of the desired use of the radar, notably:
the carrier frequency: this frequency is a key parameter in the design of a radar. It determines both the accessible angular resolution, together with the size of the radar. It is also related to the available technologies and to their performance capabilities (notably accessible transmission power and noise factor) in terms of the range budget of the radar. The selected carrier frequency is also related to the physical parameters of the scene and its environment: back scattering coefficients of the ground surfaces, elements of the runway and its surroundings, absorption and diffusion by the atmosphere under different weather conditions. The carrier frequency of the radar is therefore a dimensional parameter and is most often determined in a given frequency band when designing the radar. The production of multiband radar is generally too expensive for the intended applications;
the transmission power is a major factor because it will directly determine the effective range of the radar but will also affect its consumption and therefore its cost.

Other parameters can be modified in real time in order to adapt the features of the radar as a function of the conditions, notably:
the waveform or modulation: this is the signal that will modulate the carrier frequency and allow detection. The waveform includes phase, amplitude, or frequency modifications as a function of time. Each waveform is adapted to a particular use and involves a compromise between various parameters (interference or multipath immunity, distance and velocity resolution, instrumented range and velocity domain, etc.);
the antenna pattern: on an electronic scanning radar that comprises numerous radiating elements, the antenna pattem depends on the combination of these various elements; the addition of phase shifters actually allows a fairly wide radar scanning domain to be artificially created that is oriented in a preferred direction without any mechanical modification of the radar;
the integration time and the processing operations performed during post-processing: they are also adapted to what is sought to be detected (Doppler filtering for searching for a moving target, suppression of ground clutter for searching for particular targets, etc.).

Using a millimeter radar for the operations of a flight vision system EFVS involves the radar being able, at any time, to provide the pilot with the best possible performance compromise, without intervention from the crew, which must concentrate on maintaining the approach trajectory.

It is important for the aircraft crew to be shown:
at the decision altitude, optimal visibility of the approach lighting (all the power of the radar therefore needs to be concentrated on the area of interest). During this flight phase, the field of view is reduced in order to guarantee the detection of the necessary visual elements at the maximum distance;
below the decision altitude:
   an increasingly wide field of view so as to allow the crew to view the whole of the runway during the approach phase. The lateral or azimuth (and optionally vertical) field of view can be progressively expanded without affecting the visibility of the approach lighting, as the required power is lower;
   an improved resolution for more precisely detecting the lighting and the contrast of the runway: the waveform can be adapted to prioritize the resolution over the range.

The electronic control unit (UCE) is configured to compute the height H of the aircraft relative to the runway threshold based on an altitude relative to the sea level that is computed based on the atmospheric pressure measured by a barometer, and/or on an altitude relative to the ground measured by a radio altimeter and/or on a distance to the runway threshold that is computed, for example, based on the position of the aircraft and the coordinates of the runway threshold or based on a radar measurement.

For example, in order to determine the height H of the aircraft relative to the runway threshold based on a distance D to the runway threshold, knowing that the aircraft follows a published approach with a known slope (often of the order of 3°) it is easy to recompute the height based on the formula H=D*tan(slope).

Determining the height H of the aircraft relative to the runway threshold based on an altitude relative to the sea level simply involves subtracting, from the altitude of the aircraft, referenced relative to the sea level, the altitude of the runway, which is also referenced relative to the sea level and is provided in the approach maps.

The electronic control unit UCE also can be configured to expand the horizontal aperture of the field of view of the millimeter radar RDRMM, as a function of manual control by the aircraft pilot.

The electronic control unit UCE can be configured to expand the horizontal aperture of the field of view of the millimeter radar from the predefined horizontal aperture of the field of view LP to a constant wider horizontal aperture when the height H of the aircraft relative to the runway threshold drops below the expansion threshold SE.

The electronic control unit UCE is configured to manage, during a landing phase on a runway, an expansion of the height or vertical aperture of the field of view CVh of the millimeter radar RDRMM around a predefined height or vertical aperture of the field of view HP, when the height H of the aircraft relative to the runway threshold becomes less than an expansion threshold SE.

As a variant, the electronic control unit UCE can be configured to gradually expand the horizontal aperture of the field of view of the millimeter radar from the predefined horizontal aperture of the field of view LP to an wider horizontal aperture depending on the height H of the aircraft, when the height of the aircraft relative to the runway threshold drops below the expansion threshold SE.

For example, the expansion of the horizontal aperture of the field of view can be linear from the predefined value LP at the expansion threshold SE to its maximum, for example, reached at an aircraft height equal to 100 feet.

Furthermore, gradually expanding the scanning domain of the millimeter radar from the predefined horizontal aperture of the field of view LP to an wider horizontal aperture depending on the height H of the aircraft, when the height H of the aircraft relative to the runway threshold drops below the expansion threshold SE, can take into account the position of the aircraft and the runway width provided by a database.

The aim is to be able to ensure that the entire width of the runway remains visible in the radar for as long as possible. For example, at 100 feet from the ground and on a 3° slope, a 40 m wide runway appears to the pilot with an angle of +/−4°. The scanning width therefore needs to be at least equal to 8° at 100 feet from the ground.

The electronic control unit UCE can be configured to gradually expand the horizontal aperture of the field of view of the millimeter radar from the predefined horizontal aperture of the field of view LP to an wider horizontal aperture depending on the height H of the aircraft, when the height H of the aircraft relative to the runway threshold drops below the expansion threshold SE, taking into account data representing further details of the parameters comprising the attitude, and/or the drift, and/or the position of the aircraft.

The electronic control unit UCE is configured to gradually expand the horizontal aperture of the field of view of the millimeter radar from the predefined horizontal aperture of the field of view LP to an wider horizontal aperture depending on the height H of the aircraft, when the height H of the aircraft relative to the runway threshold drops below the expansion threshold SE, taking into account characteristic data of the yaw stability of the aircraft.

The electronic control unit UCE can be configured to modify the waveform of the millimeter radar RDRMM when the height H of the aircraft relative to the runway threshold becomes less than a modification threshold SM.

The modification threshold SM can be equal to the expansion threshold SE, as shown in the example of FIG. 2.

The modification of the waveform can be of any type, for example, transitioning to another constant value, or can be continuously modified, or modified by a series of constant values at successive altitude ranges.

The electronic control unit UCE can be configured to expand the horizontal aperture of the field of view of the millimeter radar RDRMM, and/or to modify the waveform of the millimeter radar RDRMM, as a function of manual control by the aircraft pilot.

1. A flight vision system (EFVS) for an aircraft, comprising a millimeter radar (RDRMM) and an electronic control unit (UCE) configured to manage, during a landing phase on a runway, an expansion of the horizontal aperture of the field of view (CVa) of the millimeter radar (RDRMM) around a predefined horizontal aperture of the field of view (LP) depending on the drift of the aircraft, when the height (H) of the aircraft relative to the runway threshold becomes less than an expansion threshold (SE).

2. The system as claimed in claim 1, wherein the electronic control unit (UCE) is configured to manage, during a landing phase on a runway, an expansion of the vertical aperture of the field of view (CVh) of the millimeter radar (RDRMM) around a predefined vertical aperture of the field of view (HP), when the height (H) of the aircraft relative to the runway threshold becomes less than the expansion threshold (SE).

3. The system as claimed in claim 1, wherein the electronic control unit (UCE) is configured to compute the height of the aircraft relative to the runway threshold based on an altitude relative to the sea level, with said altitude relative to the sea level being computed based on the atmospheric pressure measured by a barometer, and/or on an altitude relative to the ground measured by a radio altimeter and/or on a distance to the runway threshold.

4. The system as claimed in claim 1, wherein the electronic control unit (UCE) is configured to expand the horizontal aperture of the field of view (CVa) of the millimeter radar from the predefined horizontal aperture of the field of view (LP) to a constant wider horizontal aperture, when the height of the aircraft relative to the runway threshold drops below the expansion threshold (SE).

5. The system as claimed in claim 1, wherein the electronic control unit is configured to gradually expand the horizontal aperture of the field of view (CVa) of the millimeter radar from the predefined horizontal aperture of the field of view (LP) to a widerhorizontal aperture depending on the height (H) of the aircraft, when the height (H) of the aircraft relative to the runway threshold drops below the expansion threshold (SE).

6. The system as claimed in claim 5, wherein the electronic control unit (UCE) is configured to gradually expand the horizontal aperture of the field of view (CVa) of the millimeter radar from the predefined horizontal aperture of the field of view (LP) to a wider horizontal aperture depending on the height (H) of the aircraft, when the height (H) of the aircraft relative to the runway threshold drops below the expansion threshold (SE), taking into account the position of the aircraft and the runway width provided by a database.

7. The system as claimed in claim 5, wherein the electronic control unit (UCE) is configured to gradually expand the horizontal aperture of the field of view (CVa) of the millimeter radar from the predefined horizontal aperture of the field of view (LP) to a wider horizontal aperture depending on the height (H) of the aircraft, when the height (H) of the aircraft relative to the runway threshold drops below the expansion threshold (SE), taking into account data representing further details of the parameters comprising the attitude, and/or the drift, and/or the position of the aircraft.

8. The system as claimed in claim 5, wherein the electronic control unit is configured to gradually expand the horizontal aperture of the field of view (CVa) of the millimeter radar from the predefined horizontal aperture of the field of view (LP) to a wider horizontal aperture depending on the height (H) of the aircraft, when the height (H) of the aircraft relative to the runway threshold drops below the expansion threshold (SE), taking into account characteristic data of the yaw stability of the aircraft.

9. The system as claimed in claim 1, wherein the electronic control unit (UCE) is configured to modify the waveform of the millimeter radar (RDRMM) when the height (H) of the aircraft relative to the runway threshold becomes less than a modification threshold (SM).

10. The system as claimed in claim 9, wherein the modification threshold (SM) is equal to the expansion threshold (SE).

11. The system as claimed in claim 1, wherein the electronic control unit (UCE) is further configured to expand the horizontal aperture of the field of view (CVa) of the millimeter radar (RDRMM), and/or to modify the waveform of the millimeter radar (RDRMM), as a function of manual control by the aircraft pilot.
